(19) United States
(12) Patent Application Publication
(10) Pub. No.: US 2009/0328084 A1
(43) Pub. Date: Dec. 31, 2009

(54) PICKUP APPARATUS

(75) Inventor: Kazuaki Okada, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/439,762

(22) PCT Filed: Sep. 4, 2006
(86) PCT No.: PCT/JP2006/317430

§ 371 Date: Mar. 3, 2009

(51) Int. Cl. G11B 33/14

(52) U.S. Cl. 720/649; G9B/33.035

(57) ABSTRACT

A pickup device (5) is provided with a pickup body (51) as a case; a heat source (61) thermally connected to the pickup body; and an optical component (13), which is fixed to the pickup body by a plurality of fixing sections including at least two fixing sections (131, 132) which are at different distances from the heat source and belong to the pickup body. The pickup body is provided with at least one of slits (100, 101) having prescribed widths, in a direction of reducing a binding force (F) which is a factor of preventing at last one fixing section (132) of the two fixing sections from being displaced due to thermal expansion in accordance with the distance from the heat source.

### TECHNICAL FIELD

The present invention relates to, for example, a pickup apparatus which can reduce an optical axis shift or misalignment caused by thermal expansion.

### BACKGROUND ART

In the vicinity of optical components provided for this type of pickup apparatus, a component which can be a high-temperature heat generation source (laser diode: LD, laser diode driver: LDD, or the like) is disposed. In general, such a high-temperature heat generation source can be a cause of the optical axis shift. For example, it is assumed that a half mirror, which is one example of the optical components, is fixed to two support members, which are one portion of a pickup body, by an adhesive at two points per support member: at four points in total. At this time, their materials are different, so their coefficients of thermal expansion are also different. Thus, if a heat is applied at each point, different expansion is produced at each point. In this case, the position of the adhesive at any one of the four points is shifted from a mounting surface, which is defined by the adhesive at the other three points. Therefore, the adhesive at this one point easily get exfoliated, and if the adhesive exfoliates, the so-called optical axis shift or misalignment possibly occurs in which the optical axis of an optical pickup apparatus is misaligned.

In order to deal with such an optical axis shift, such a technique has been suggested that for example, a half mirror is fixed by an adhesive dropped at three points in total, which are between the both sides of the half mirror and two support members (refer to a patent document 1). According to this technique, deflection does not occur on the mounting surface, defined by the adhesive at the three points, so it is possible to prevent any of the adhesive from exfoliating; namely, the optical axis shift can be supposedly reduced.

Patent document 1: Japanese Patent Application Laid Open NO. 2002-100062

### DISCLOSURE OF INVENTION

### Subject to be Solved by the Invention

However, for example, according to the technique disclosed in the aforementioned patent document 1, although the exfoliation of the adhesive can be prevented, there is still the following potential problem; namely, the heat of the heat generation source is conducted to the pickup body and deforms the pickup body, so the half mirror fixed to the pickup body is also displaced and the optical axis shift possibly remains.

In view of the aforementioned problem, it is therefore an object of the present invention to provide a pickup apparatus which can preferably reduce the optical axis shift or misalignment caused by thermal expansion.

### Means for Solving the Subject

The above object of the present invention can be achieved by a pickup apparatus provided with: a pickup body as a case; a heat source thermally connected to the pickup body; and an optical component fixed to the pickup body by a plurality of fixing parts including at least two fixing parts whose distances from the heat source are different from each other and which belong to the pickup body, the pickup body having at least one slit with a predetermined width, formed in a direction of reducing a binding force, which is a factor to prevent at least one of the two fixing parts from being displaced by thermal expansion corresponding to the distance from the heat source.

According to the pickup apparatus, the pickup body is provided as the case, and the heat source is thermally connected to the pickup body. The “heat source” is various parts accompanied by heat generation, such as a LD and a LDD. The expression “thermally connected” denotes that heat exchange is possible for each other. Moreover, the optical component such as a lens or a mirror is fixed to the pickup body by the plurality of fixing parts including at least the two fixing parts whose distances from the heat source are different from each other. The two fixing parts indicate one portion of the bottom surface of the pickup body and one portion of the wall surface of the side wall, which are adhered to the optical component by an adhesive. Incidentally, the two fixing parts only need to have different distances from the heat source, and the two fixing parts are not necessarily separated. For example, even two portions which are adjacent to each other and which are selected from an area in which the adhesive is applied in the wall surface of the side wall, can correspond to the two fixing parts because the area is spatial and the two portions have different distances from the heat source.

Here, in the operation of the pickup apparatus, the heat source produces heat, so thermal expansion corresponding to the distance from the heat source allows each of the two fixing parts to be displaced. Moreover, the two fixing parts have different distances from the heat source, so the amounts of displacement are also different from each other if the two fixing parts are displaced in accordance with the distance. At this time, if action is not taken, the difference in the amount of displacement between the two fixing parts causes more inclination of the straight line which connects the two fixing parts, compared to without thermal expansion; namely, the fixed optical component inclines, which likely causes the optical axis shift caused by thermal expansion.

In the pickup body in the present invention, however, at least one of the two fixing parts has at least one slit with the predetermined width formed in the direction of reducing the binding force, which is the factor to prevent at least one of the two fixing parts from being displaced by thermal expansion corresponding to the distance from the heat source. Therefore, the optical axis shift can be reduced in the following manner. Here, the “slit” is a gap, a thin and long aperture, or a thin and long cut, and the shape of the cut is no object. The “predetermined width” is, in a narrow sense, a value which can be defined by the degree of thermal expansion, the depth of the slit, the strength of a mold, the scale of the pickup apparatus, or the like; however, the employment of a determined value such as 0.3 [mm] produces an effect to a greater or lesser effect. The “binding force” is the fact to prevent at least one of the two fixing parts from being displaced, and it indicates a force received from a surrounding member which is uniformly or integrally formed with the one fixing part, and specifically an intermolecular force, which enables a material to be solid. The “direction of reducing the binding force” is specifically a direction of crossing the binding force, or a direction of cutting off the binding force. The one fixing part and the other fixing part belong to the same pickup body and are mechanically connected. Thus, as the other fixing part is displaced by thermal expansion, the one fixing part is displaced. At this time, the aforementioned formation of the slit allows the binding force acting on the one fixing part to be reduced and facilitates the displacement of the one fixing part. In other words, the difference in the amount of displacement between the two fixing parts is smaller, compared to when the slit is not formed. Therefore, the extent of inclination of the straight line which connects the second fixing part is also reduced. Hence, the inclination of the fixed optical component is reduced, by which it is possible to preferably reduce the optical axis shift caused by thermal expansion, and it is extremely useful in practice.

In another aspect of the pickup apparatus of the present invention, the direction in which the slit is formed crosses an optical axis of a laser beam which is transmitted through or reflected on the fixed optical component.

According to this aspect, the slit is formed in the direction of crossing the optical axis of the laser beam which is transmitted through or reflected on the fixed optical component. In other words, the depth direction of the slit is the direction of crossing the optical axis. Here, the binding force acting in the direction along the optical axis influences the amount of displacement in the direction along the optical axis, which inclines the optical component with respect to the optical axis and can cause the optical axis shift. The aforementioned formation of the slit, however, reduces such a binding force, which reduces the difference in the amount of displacement in the direction along the optical axis, so that the optical axis shift can be preferably reduced.

In one aspect of the pickup apparatus of the present invention, the direction in which the slit is formed follows a straight line which connects the two fixing parts or two points which belong to the respective two fixing parts.

According to this aspect, the slit is formed in the direction along the straight line which connects the two fixing parts. The two fixing parts, however, are not points in a narrow sense, so it is hard to define the straight line which connects them. In this case, instead of the two fixing parts, two points which belong to the respective two fixing parts may be selected. If the slit is formed in this manner, the binding force acting in the direction of crossing the straight line can be cut off and reduced. Therefore, the degree of inclination of the straight line which connects the two fixing parts is also reduced. Hence, it is possible to preferably reduce the optical axis shift.

In another aspect of the pickup apparatus of the present invention, the at least one fixing part is the fixing part with a smaller amount of displacement of the two fixing parts.

According to this aspect, the binding force is reduced at least for the one fixing part with the smaller amount of displacement, of the two fixing parts which are displaced with thermal expansion. In other words, the binding force is reduced for the one fixing part which has a longer distance from the heat source. Hence, as the other fixing part is relatively significantly displaced, the one fixing part is displaced without an impediment by the binding force. Therefore, it is possible to reduce the difference in the amount of displacement between the two fixing parts, compared to when the slit is not formed.

In another aspect of the pickup apparatus of the present invention, the two fixing parts are a first fixing part which belongs to a bottom surface of the pickup body; and a second fixing part which belongs to a wall surface of a side wall which stands on the bottom surface.

According to this aspect, the optical component is fixed by the two fixing parts, which are the first fixing part, which belongs to the bottom surface of the pickup body; and the second fixing part, which belongs to the wall surface. At this time, since the bottom surface and the wall surface have different distances from the heat source, the amounts of displacement of the two fixing parts are different, so that the optical axis shift likely occurs. According to this aspect, however, the slit is formed regarding at least the one fixing part, of the bottom surface or the wall surface. For example, the slit is formed in the wall surface. If so, the binding force in the wall surface is reduced, and the second fixing part which belongs to the wall surface is easily displaced in accordance with the first fixing part which belongs to the bottom surface. Therefore, the difference in the amount of displacement between the two fixing parts can be reduced, compared to when the slit is not formed.

In another aspect of the pickup apparatus of the present invention, the slit is formed in each of the bottom surface of the pickup body and the wall surface of the side wall which stands on the bottom surface.

According to this aspect, for example, if the optical component is fixed by the two fixing parts, which are the first fixing part, which belongs to the bottom surface of the pickup body; and the second fixing part which belongs to the wall surface, the influence of the displacement by thermal expansion is eased not only in the wall surface but also in the bottom surface. In other words, the influences are eased on the inclination of the optical component by the displacement of the two fixing parts. Therefore, the optical axis shift can be further reduced.

In this aspect, the slits, formed in each of the bottom surface of the pickup body and the wall surface of the side wall which stands on the bottom surface, may be formed in conjunction with each other.

According to this aspect, for example, if the optical component is fixed by the two fixing parts, which are the first fixing part which belongs to the bottom surface of the pickup body and the second fixing part which belongs to the wall surface, the slit is formed from the wall surface to the bottom surface. Therefore, the amounts of displacement in the first fixing part and the second fixing part are further matched, so the optical axis shift can be further reduced.

In another aspect of the pickup apparatus of the present invention, the slit is formed in each of a surface of the pickup body to which one of the two fixing parts belongs and a surface to which the other of the two fixing parts belongs.

According to this aspect, if the optical component is fixed by the two fixing parts, which are the one fixing part, which belongs to one surface of the pickup body; and the other fixing part, which belongs to another surface of the pickup body, the influences of the displacement by thermal expansion are eased in not only one surface but also another surface. In other words, the influences on the inclination of the optical component by the displacement of the two fixing parts are eased in thermal expansion. Therefore, the optical axis shift can be further reduced.

In this aspect, the slits, formed in both of a surface of the pickup body to which one of the two fixing parts belongs and a surface to which the other of the two fixing parts belongs, may be formed in conjunction with each other.

According to this aspect, if the optical component is fixed by the two fixing parts, which are the one fixing part which belongs to one surface of the pickup body and the other fixing part which belongs to another surface of the pickup body, the slit is formed from the wall surface to the bottom surface. Therefore, the amounts of displacement between the two fixing parts are further matched, so the optical axis shift can be further reduced.

As explained above, according to the pickup apparatus of the present invention, it is provided with the pickup body, the heat source, the optical component, and the slit. Thus, it is possible to preferably reduce the optical axis shift caused by thermal expansion.

### BRIEF DESCRIPTION OF DRAWINGS

FIG. 1 is an exploded perspective view showing a disc apparatus provided with a pickup apparatus, in an embodiment of the present invention.

FIG. 2 are schematic stereo views showing a pickup apparatus in a first embodiment observed from various directions (a: top view with optical components, b: top view without optical components, c: perspective view without optical components).

FIG. 3 are side views showing a positional relationship between an optical axis and a half mirror fixed to a pickup apparatus in a comparison example (a: before thermal expansion, b: after thermal expansion).

FIG. 4 are side views showing the positional relationship between the optical axis and the half mirror fixed to the pickup apparatus in the first embodiment (a: before thermal expansion, b: after thermal expansion).

FIG. 5 are schematic stereo views showing a pickup apparatus in a second embodiment observed from various directions (a: top view with optical components, b: top view without optical components, c: perspective view without optical components).

### DESCRIPTION OF REFERENCE CODES

1 disc apparatus
41 optical disc
5 pickup apparatus
51 pickup body
61 laser beam source
81 laser holding device
11 synthetic prism
12 collimator
75 multi-lens
72 OEIC plate
13 half mirror
95 body bottom surface
96 body-bottom hole
97 body side wall
98 body wall surface
100 first slit
101 second slit

### BEST MODE FOR CARRYING OUT THE INVENTION

Hereinafter, the best mode for carrying out the present invention will be explained in order in each embodiment with reference to the drawings.

### (1) First Embodiment

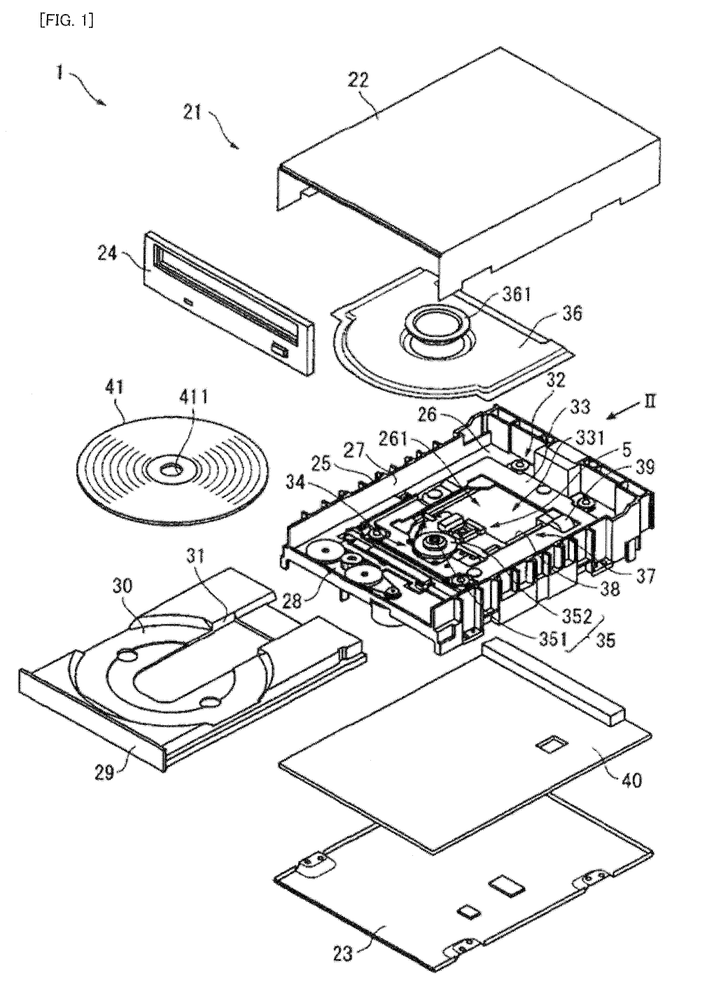

With reference to FIG. 1 to FIG. 4, an explanation will be given on the basic structure of a pickup apparatus in a first embodiment.

Firstly, an explanation will be given on the structure of a disc apparatus 1 provided with a pickup apparatus 5 in the embodiment, with reference to FIG. 1. FIG. 1 is an exploded perspective view showing the disc apparatus provided with the pickup apparatus, in the embodiment of the present invention.

In FIG. 1, the disc apparatus 1 is a disc apparatus for reproducing information recorded on an optical disc 41 such as a DVD or for recording information onto the optical disc 41. The disc apparatus 1 is provided with an outer case 21; an inner case 25 located within the outer case 21; a disc tray 29, which is disposed so that it can enter and emerge from the inner case 25 and on which the optical disc 41 as an optical recording medium is placed; a main body 32, which is disposed in the inner case 25 and which reproduces or records the information with respect to the optical disc 41; and a circuit substrate 40 having electronic components for controlling the operation of the main body 32.

The outer case 21 is provided with an upper case 22 in which a lower surface and a front surface are open in FIG. 1; a lower case 23 which blocks the lower surface of the upper case 22; and a decorative laminate 24 which blocks the front surface of the upper case 22. The outer case 21 is flat and rectangular as a whole.

The inner case 25 has a case bottom surface 26 in which the upper surface and the front surface are open and which has a hole 261 in a substantially center; and case side surfaces 27 which stand on the case bottom surface 26.

The disc tray 29 is substantially plate-like and has a mounting concave part 30 on the upper surface, which is circular and concave, whose radius increases upward, and on which the optical disc 41 is placed. The disc tray 29 enters and emerges by virtue of a tray driving device 28 provided for the inner case 25.

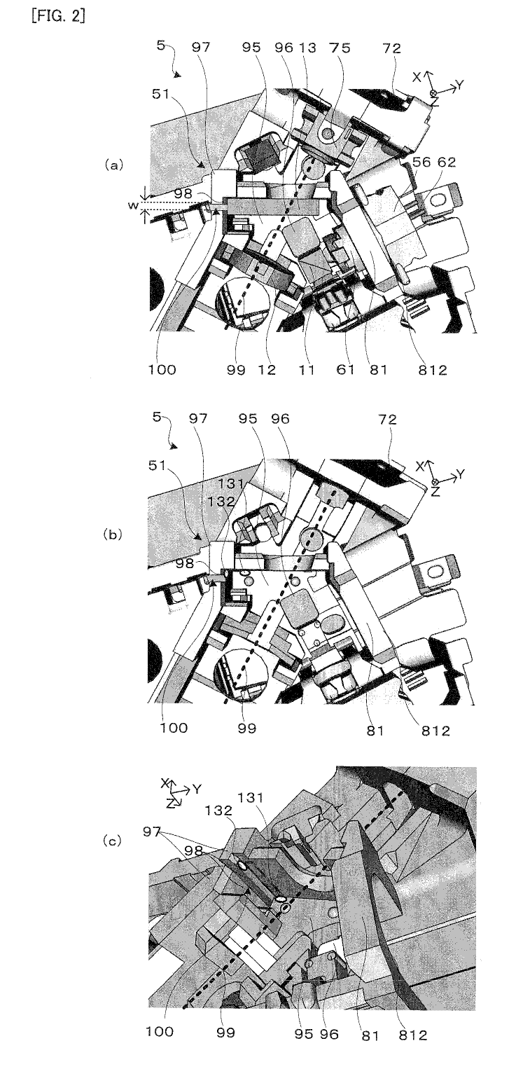

The main body 32 is provided with a base 33, which has a hole 331 in the center and which is disposed in the inner case 25; a rotation driving device 34, which is disposed on the base 33, for rotating the optical disc 41; a pickup apparatus 5, which is displaced from one edge the other edge of the hole 333 of the base 33 and which irradiates a laser beam and detects reflected light with respect to a recording device disposed on the lower surface side of the optical disc 41; and a displacing device 37 for displacing the pickup apparatus 5 back and forth. The base 33 is formed in a plate frame shape and is disposed so that the hole 331 of the base 33 overlaps the hole 261 of the inner case 25. The rotation driving device 34 is provided with a turntable for rotating, with the optical disc 41 placed thereon; and a spindle motor (not illustrated) as a power source for rotationally driving the turntable 35. The turntable 35 has a rotating shaft 351 inserted and fitted in a central hole 411 of the optical disc 41; and a flange 352 which is provided in a protruding manner in a flange shape on the outer circumferential surface of the rotating shaft 351 and on which the rim of the shaft hole of the optical disc 41 is placed. When the optical disc 41 is placed on the disc tray 29 and is displaced to the inner side of the inner case 25, the optical disc 41 is placed on the turntable 35, and the upper surface of the optical disc 41 is held by a rotator 361, which is rotatably provided for a supporting member 37 bridged to the case side surfaces of the inner case 25. The optical disc 41 is rotated by the driving force of a spindle motor, with the optical disc 41 being sandwiched between the turntable 35 and the rotator 361. The pickup apparatus 5 will be described later with reference to FIG. 2. The displacing device 37 is provided with a pair of guide shafts 38 and a moving motor 39. The guide shafts 38 are provided at respective predetermined positions in the axial direction from one edge to the other edge of the hole 331 of the base 33. The guide shafts 38 are inserted into or engaged with the pickup apparatus 5. The pickup apparatus 5 is displaced from one edge to the other edge of the base 33 by the driving force of the moving motor 39.

The circuit substrate 40 is disposed below the pickup apparatus 5 at a predetermined distance from the pickup apparatus 5. The circuit substrate 40 has electronic components for performing the rotation control of the moving motor 39 and the spindle motor, the control of the pickup apparatus 5, and the like.

An explanation will be given on the information reading from the optical disc 41 by the disc apparatus 1 with the aforementioned structure. Firstly, a user pulls out the disc tray 29 from the outer case 21 and the inner case 25 and places the optical disc 41 on the disc tray 29. The disc tray 29 with the optical disc 41 placed thereon is housed into the inner case 25. Then, the optical disc 41 is sandwiched between the turntable 35 and the rotator 361, and the rotation of the turntable 35 allows the optical disc 41 to be rotated. At this time, a laser beam is emitted from the pickup apparatus 5 to the optical disc 41, and the reflected light from the optical disc 41 is detected on the pickup apparatus 5. The detection of the reflected light allows the information reading from the optical disc 41. The pickup apparatus 5 also irradiates the laser beam in a predetermined portion of the optical disc 41 by the displacement of the displacing device 37. This allows predetermined information to be sequentially read from the optical disc 41.

Next, the structure of the pickup apparatus 5 in the embodiment will be explained with reference to FIG. 2 to FIG. 4, while comparing it with that of the pickup apparatus 5 in a comparison example, as occasion demands. FIG. 2 are schematic stereo views showing a pickup apparatus in a first embodiment observed from various directions (a: top view with optical components, b: top view without optical components, c: perspective view without optical components).

In FIG. 2(a), FIG. 2(b), and FIG. 2(c), the pickup apparatus 5 is provided with a pickup body 51; a laser light source 61; a laser holding device 81; a synthesis prism 11; a collimator lens 12; a multi-lens 75; an OEIC plate 72; and a half mirror 13. Moreover, a laser beam emitted from the laser light source 61 is transmitted through the optical components, and an optical axis 99 is defined.

The pickup body 51 is one example of the “pickup body” of the present invention and is formed of a synthetic resin or the like. A body bottom surface 95 of the pickup body 51 has a substantially thick plate shape, has an optical component such as the laser light source 61 on one side, and has a laser reflecting device (not illustrated) for reflecting the laser beam toward the optical disc 41 on the other side. On the body bottom surface 95, one or a plurality of body bottom holes 96, which penetrate from one side to the other side, are formed. This hole is used, for example, as a path of the laser beam or the air. A body side wall 97 is integrally formed with the body bottom surface 95 and stands on the body bottom surface 95 with a predetermined height. The body side wall 97 has a first slit 100 formed in a Z-axis direction as if the first slit 100 divided the body side wall 97, wherein the first slit 100 is one example of the “slit” of the present invention and which is a long and thin cut with a width w. The width w is a value determined by the strength of a mold or the like, for example, 0.3 [mm]. FIG. 1 show one first slit 100; however, a plurality of first slits 100 may be formed as long as the strength of the body side wall 97 permits. In this case, the width and depth of each slit may be different from each other.

The laser light source 61 is one example of the “heat source” of the present invention and produces heat when the laser beam is emitted with a wavelength corresponding to the type of the optical disc 41. The laser light source 61 is exposed on one edge surface to the exterior from a laser light source housing device 56 and has a connector pin 62 to which a power cable (not illustrated) or the like is connected on the one edge surface.

The laser holding device 81 protrudes from the body surface 95 of the pickup body 51 in a negative direction of the Z axis and has a holding hole 812 to hold the laser light source 61. The holding hole 812 is a hole, which has an equal or greater radius than the outer radius of the laser light source 61 and which penetrates in a Y-axis direction. The laser light source 61 is inserted and held in the holding hole 812. The laser light source 61 held by the pickup body 51 in this manner is in contact with the pickup body 51 and is thermally connected, so the heat produced from the laser light source 61 is conducted to the pickup body 51.

The synthesis prism 11 is, for example, an optical component which can reflect or transmit the laser light therethrough using light diffraction phenomenon. The synthesis prism 11 changes the optical path of the laser beam emitted from the laser light source 61, as occasion demands.

The collimator lens 12 emits the incident laser beam as parallel light.

The multi-lens 75 is adapted to focus signal light from a recording surface of the optical disc 41 on an OEIC (not illustrated) attached to the OEIC plate 72 at a high light collection efficiency.

The OEIC is provided with, for example, a photo diode. The OEIC receives the signal light (or return light), which is focused by the multi-lens 75, from the recording surface of the optical disc 41.

The half mirror 13 is one example of the “optical component” of the present invention and divides the incident laser beam into transmitted light and reflected light at a predetermined ratio. The half mirror 13 is fixed to the pickup body 51 by a plurality of fixing parts including at least two fixing parts whose distances from the laser light source 61 are different from each other. Specifically, the half mirror 13 is fixed by a first fixing part 131 which belongs to the body bottom surface 95 and a second fixing part 132 which belongs to a body wall surface 98 of the body side wall 97 which stands on the body bottom surface 95 (refer to FIG. 2(b) and FIG. 2(b)). In other words, the first fixing part 131 and the second fixing part 132 are one example of the “two fixing parts whose distance from the heat source are different from each other” in the present invention.

The optical axis 99 is the optical axis of the laser beam emitted from the laser light source 61. For example, as shown in a dashed line in FIG. 2(c), the optical axis 99 is defined as follows, through various optical components provided for the pickup body 51; namely, the optical axis 99 is obtained by connecting the collimator 12, the half mirror 13, the multi-lens 75, and the OEIC.

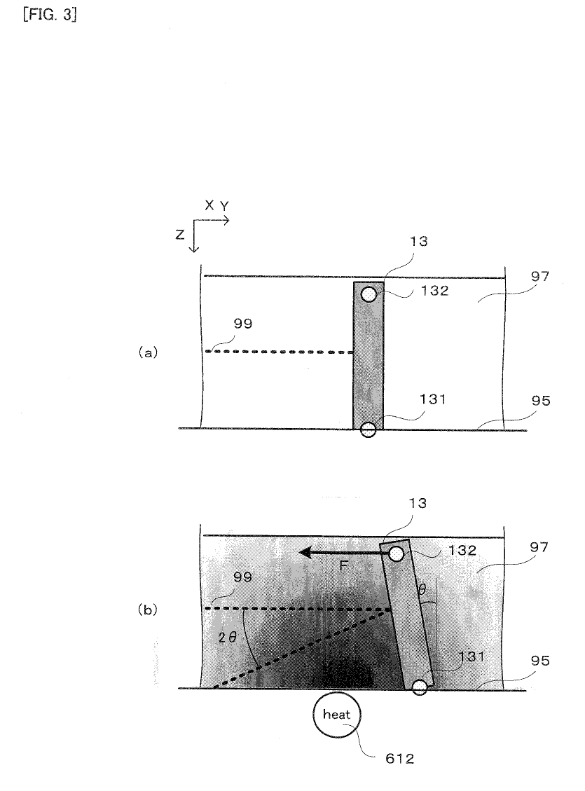

Now, in order to perform the recording or reproduction on the optical disc 41, the various optical components need to be strictly disposed so that the optical axis 99 eventually preferably received by the OEIC. However, if the first lit 100 is not formed, a so-called optical axis shift can occur in which the optical axis 99 is shifted from the normal position as shown in FIG. 3. FIG. 3 are side views showing a positional relationship between an optical axis and a half mirror fixed to a pickup apparatus in a comparison example (a: before thermal expansion, b: after thermal expansion).

In FIG. 3(a) and FIG. 3(b), on the body side wall 97 which erects with respect to the body bottom surface 95, the half mirror 13 is fixed by the first fixing part 131 which belongs to the body bottom surface 95 and the second fixing part 132 which belongs to the body wall surface 98 of the body side wall 97 which stands on the body bottom surface 95. As opposed to the embodiment, since the first slit 100 is not formed on the body side wall 97, a binding force F is not reduced, so the so-called optical axis shift can occur.

More specifically, as shown in FIG. 3(a), before thermal expansion, the reflecting surface of the half mirror 13 is parallel to the Z axis. Hence, the incident direction and the reflection direction of the laser beam which enters at right angle to the Z-axis direction are the same at least with respect to the Z-axis component. In other words, the so-called optical axis shift does not occur. Incidentally, the expression “at least with respect to the Z-axis component” indicates that the incident direction and the reflection direction do not necessarily the same with respect to the X-axis component and the Y-axis component.

As shown in FIG. 3(b), however, after thermal expansion, the reflecting surface of the half mirror 13 is inclined at about an angle of θ from the Z-axis direction, so the so-called optical axis shift occurs. More specifically, for example, each part is relatively changed in accordance with the distance from a heat source 612 such as the laser light source 61 in operation. Here, the first fixing part 131 and the second fixing part 132, which fix the half mirror 13, have different distances from the heat source 612, so the amounts of displacement in the fixing parts are different from each other. Specifically, the first fixing part 131 has a shorter distance from the heat source 612 than the second fixing part 132, so the first fixing part 131 is displaced more significantly than the second fixing part 132 by that much. At this time, the first fixing part 131 and the second fixing part 132 are considered to belong to the same pickup body 51 and to be mechanically connected, so as the first fixing part 131 is displaced significantly, the second fixing part 132 can be also displaced. However, a vicinity of the second fixing part 132 of the body side wall 97 also has a relatively small amount of displacement since its distance from the heat source 612 is longer than the first fixing part 131. This vicinity keeps having the small amount of displacement because of inertia and can prevent the second fixing part 132 mechanically connected by an intermolecular force from being displaced. In other words, the vicinity of the second fixing part 132 can operate as an impediment to the second fixing part 132 through the intermolecular force or the like, i.e. as one example of the “binding force” of the present invention. Thus, the reflecting surface of the half mirror 13 is inclined at about the angle from the Z-axis direction. Hence, the incident direction and the reflection direction of the laser beam which enters at right angle to the Z-axis direction (=reflecting surface) are difference with respect to the Z-axis component. Specifically, the reflection direction is shifted at about an angle 2θ from the incident direction. In other words, the so-called optical axis shift occurs.

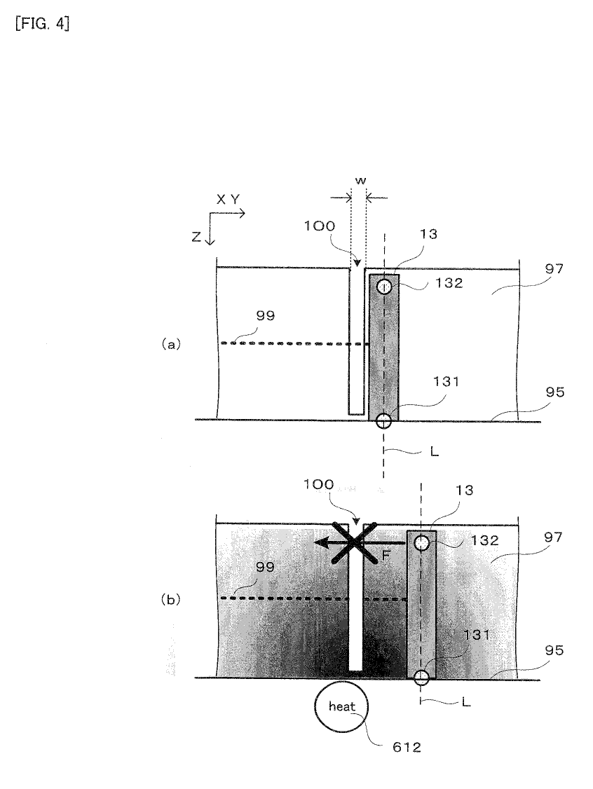

On the other hand, the pickup apparatus 5 in the embodiment has the first slit 100 formed as shown in FIG. 2, so the optical axis shift is reduced as shown in FIG. 4. FIG. 4 are side views showing the positional relationship between the optical axis and the half mirror fixed to the pickup apparatus in the first embodiment (a: before thermal expansion, b: after thermal expansion).

In FIG. 4(a) and FIG. 4(b), particularly in the embodiment, the first slit 100 is formed in the body side wall 97, so that the so-called the optical axis shift can be reduced.

More specifically, as shown in FIG. 4(a), as in the comparison example in FIG. 3(a), the so-called optical axis shift does not occur before thermal expansion.

In the embodiment, moreover, as shown in FIG. 4(b), the so-called optical axis shift does not occur at all or hardly occurs even after thermal expansion. This is because the binding force F by the vicinity of the second fixing part 132, which is the cause of the binding force in the comparison example, is reduced by the first slit 100. As described above, without the impediment, the second fixing part 132 can be displaced as the first fixing part 131 is displaced. At this time, the fixed half mirror 13 is slid along the body bottom surface 95, which allows the optical axis shift, which can occur in the comparison example, to be eliminated or reduced.

In summary, the pickup apparatus 5 in the embodiment achieves the following operation and effect.

Firstly, as described above, the first slit 100 is formed in the body side wall 97. Therefore, even if the pickup body 51 is thermally expanded because of the operation of the laser light source 61, the factor which binds the second fixing part 132 is eliminated, so the optical axis shift caused by thermal expansion can be preferably reduced.

At this time, the first slit 100 is formed in a direction (i.e. Z-axis direction) of crossing the optical axis 99. Therefore, the binding force acting in the direction along the optical axis 99 is reduced, and it is possible to reduce a difference in the amount of displacement in the direction along the optical axis 99 associated with the first fixing part 131 and the second fixing part 132.

In addition, the first slit 100 is formed in a direction along a straight line L, which connects the first fixing part 131 and the second fixing part 132 (cf. FIG. 4). Such a formation reduces the binding force acting in the direction of crossing the straight line L, so the degree of inclination of the straight line L is reduced.

In addition, of the first fixing part 131 and the second fixing part 132 which are displaced with thermal expansion, at least the binding force with respect to the second fixing apart 132, which has a longer distance from the laser light source 61, is reduced. Hence, as the first fixing part 131, which has a shorter distance from the laser light source 61, is relatively significantly displaced, the second fixing part 132 is displaced without the impediment by the binding force.

As explained above, according to the pickup apparatus 5 in the embodiment, it is possible to preferably reduce the optical axis shift caused by thermal expansion, which is extremely useful in practice.

### (2) Second Embodiment

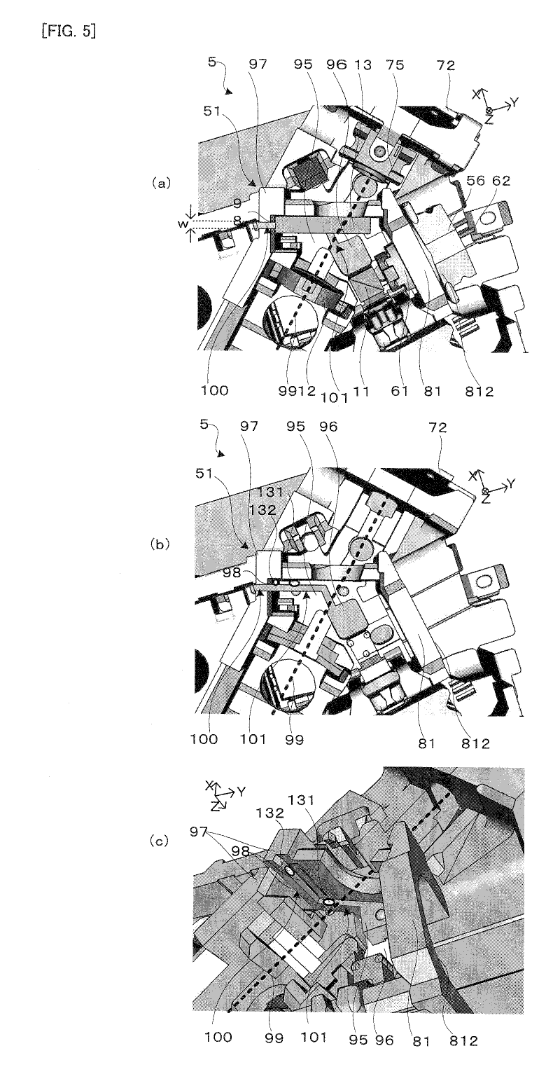

Next, the structure and operation process of the pickup apparatus 5 in a second embodiment will be explained with reference to FIG. 5 in addition to FIG. 1 to FIG. 4. FIG. 5 are schematic stereo views showing the pickup apparatus in the second embodiment observed from various directions (a: top view with optical components, b: top view without optical components, c: perspective view without optical components). Incidentally, the same components as those in the aforementioned first embodiment carry the same numerical references, and the explanation thereof will be omitted as occasion demands.

In the embodiment, in particular, in FIG. 5(a), FIG. 5(b), and FIG. 5(c), in addition to the first slit 100 formed in the body side wall 97, a second slit 101 is formed in the body bottom surface 95. Therefore, the optical axis shift can be further reduced.

More specifically, the slits (the first slit 100 and the second slit 101) are also formed on both the first fixing part 131 and the second fixing part 132. Therefore, influences on the inclination of the half mirror 13, caused by the displacement of both the fixing parts, are eased in the thermal expansion.

At this time, the first slit 100 and the second slit 101 are formed in conjunction with each other. In addition, the second slit 101 is also formed in conjunction with the body bottom hole 96. Therefore, the amounts of displacement of the first fixing part 131 and the second fixing part 132 are further matched.

As described above, according to the embodiment, the optical axis shift caused by thermal expansion can be further reduced, which is extremely useful in practice.

Incidentally, in the aforementioned embodiments, the half mirror 13 is used as the optical component; however, the application target of the present invention is not limited to this. For example, it can be applied to the multi-lens 75, the collimator 12, and the like. At this time, the position, width, depth, or the like of the formed slit may be changed, as occasion demands.

The present invention is not limited to the aforementioned embodiment, but various changes may be made, if desired, without departing from the essence or spirit of the invention which can be read from the claims and the entire specification. A pickup apparatus, which involves such changes, is also intended to be within the technical scope of the present invention.

### INDUSTRIAL APPLICABILITY

The pickup apparatus of the present invention can be applied to a high-density optical disc such as a DVD, and can be also applied to an information recording apparatus such as a DVD recorder. Moreover, the pickup apparatus of the present invention can be also applied to an information recording apparatus or the like which is mounted on or which can be connected to various computer equipment for consumer use or for commercial use.

1-9. (canceled)

10. A pickup apparatus comprising:
a pickup body as a case;
a heat source thermally connected to said pickup body; and
an optical component fixed to said pickup body by a plurality of fixing parts including at least two fixing parts whose distances from said heat source are different from each other and which belong to said pickup body,
said pickup body having at least one slit with a predetermined width, formed in a direction of reducing a binding force, which is a factor to prevent one of the two fixing parts with a smaller amount of displacement from being displaced by thermal expansion corresponding to the distance from said heat source, and in a direction of crossing a conducting direction of a heat from said heat source in the other of the two fixing parts with a larger amount of displacement.

11. The pickup apparatus according to claim 10, wherein the direction in which the slit is formed crosses an optical axis of a laser beam which is transmitted through or reflected on said fixed optical component.

12. The pickup apparatus according to claim 10, wherein the direction in which the slit is formed follows a straight line which connects the two fixing parts or two points which belong to the respective two fixing parts.

13. The pickup apparatus according to claim 10, wherein the two fixing parts are a first fixing part which belongs to a bottom surface of said pickup body; and a second fixing part which belongs to a wall surface of a side wall which stands on the bottom surface.

14. The pickup apparatus according to claim 13, wherein the slit is formed in each of the bottom surface of said pickup body and the wall surface of the side wall which stands on the bottom surface.

15. The pickup apparatus according to claim 14, wherein the slits, formed in both of the bottom surface of said pickup body and the wall surface of the side wall which stands on the bottom surface, are formed in conjunction with each other.

16. The pickup apparatus according to claim 10, wherein the slit is formed in each of a surface of said pickup body to which one of the two fixing parts belongs and a surface to which the other of the two fixing parts belongs.

17. The pickup apparatus according to claim 16, wherein the slits, formed in both of a surface of said pickup body to which one of the two fixing parts belongs and a surface to which the other of the two fixing parts belongs, are formed in conjunction with each other.
